(19) United States
(12) Patent Application Publication
(10) Pub. No.: US 2012/0011061 A1
(43) Pub. Date: Jan. 12, 2012

(54) SYSTEM AND METHOD FOR CALCULATING NET PAYMENT IN SOCIAL SERVICES

(75) Inventors: Xiaopeng Tan, Mannheim (DE); Claus Steimer, Weingarten (DE); Miroslav Cina, Hanhofen (DE)

(73) Assignee: SAP AG, Walldorf (DE)

(21) Appl. No.: 12/833,300

(22) Filed: Jul. 9, 2010

(51) Int. Cl. G06Q 40/00

(52) U.S. Cl. 705/40

(57) ABSTRACT

A method and system of generating net calculation documents for issuing benefits to a recipient. The method and system may include receiving gross payment documents (GPDs) each including a plurality of gross payment items (GPIs) each including a benefit amount the recipient is entitled to and deduction plan documents (DPDs) each including a plurality of deduction plan items (DPIs) each including a deduction amount from a corresponding GPI. Responsive to receiving one of an update to at least one of the GPIs and at least one new GPIs, the method and system may further include grouping all GPIs into groups based on pre-determined criteria, determining a time period that extends over all GPIs that are affected by the updated/new GPIs and need recalculation, determining net calculation units (NCUs) each unit having an identical payment frequency, dividing the NCUs into homogeneous time slices based on benefit payment dates, and for each time slice, generating a NCD including a header, a plurality of GPIs and DPIs for the time slice.

### REFERENCE OF RELATED APPLICATIONS

This application incorporates by reference the entire contents of U.S. Non-Provisional application Nos. ______ (Attorney Docket Nos. 11884/511301, 511401, 511501, 511601, and 511801) filed on even date.

### FIELD OF THE INVENTION

The present invention is generally directed to a social service payment system. In particular, the present invention is directed to a system and method of calculating net payment to recipients of social service benefits.

### BACKGROUND

Social service agencies may provide a wide range of social benefits to the public. For example, in U.S., the social security agency may provide social security benefits in the form of monthly payments to people who are entitled to social security benefits. Other examples of social benefits may include housing allowances, food subsidies, disability insurance payments, unemployment insurance payments, and public pension payments.

A recipient (or beneficiary) of social services may be entitled to receive benefits from multiple agencies. The benefits are commonly in the form of monetary payments. The gross benefit payment may be subject to a variety of deductions before the recipient receives a net payment. The net calculation is a process to calculate net payments and which is coupled between social service decision-making process and the actuation of payment to the benefit recipient. The social service decision-making process may use a gross payment process to generate a data object called gross payment document including information relating to the gross amount that the recipient is entitled to and use a deduction process to generate another data object called deduction plan document including information relating to the variety of deductions.

The deduction process may withhold a certain amount of money from the gross payment and to redistribute the withheld amount to fulfill other obligations. One type of deductions may be based on individualized decisions. The individual decision-based deductions may include periodical fee deductions (e.g., rents, cable fees, and utility payments), claim deduction (e.g., liabilities to agencies and child supports), and personal savings. Another type of deductions may be based on rules. The rule-based deductions may include income taxes (e.g., federal and state income taxes) and social benefit taxes (e.g., social security tax).

Because of their diverse objectives of diverse social services, different social services may be mandated by different laws and subject to different regulations. For example, certain social service benefits may not be subject to certain taxes, while others do. Further, in social service arena, deductions from gross payment may require particular care because they may reduce payments to people in need. Usually, the deductions are carried out by social service case workers who may consider many factors in determining deductions.

Traditional payroll applications such as SAP payroll solution are not specifically designed for social services management. Although payroll applications may handle mass payments to a large number of recipients from a single income source, they are not designed to make payments to the large number of recipients from different social service programs, each having different deductions and posting payments to different accounts. Therefore, these payroll applications may not be integrated naturally with social service functionalities Furthermore, the total ownership cost (TOC) for operating a payroll application is usually high.

Therefore, there is a need for system and method that is specifically designed for automatically calculating net payments to a benefit recipient in social services.

### SUMMARY OF INVENTION

Embodiments of the present invention may include a method and system of generating net calculation documents for issuing benefits to a recipient. The method and system may include receiving gross payment documents (GPDs) each including a plurality of gross payment items (GPIs) each including a benefit amount the recipient is entitled to and/or receiving deduction plan documents (DPDs) each including a plurality of deduction plan items (DPIs) each including a deduction amount from a corresponding GPI. Responsive to receiving one of an update to at least one of the GPIs and at least one new GPIs, the method and system may further include grouping all GPIs into groups based on pre-determined criteria, determining a time period that extends over all GPIs that are affected by the updated/new GPIs and need recalculation, determining net calculation units (NCUs) each unit having an identical payment frequency, dividing the NCUs into homogeneous time slices based on benefit payment dates, and for each time slice, generating a NCD including a header, a plurality of GPIs and DPIs for the time slice.

### BRIEF DESCRIPTION OF THE DRAWINGS OF THE EXAMPLE EMBODIMENTS

FIG. 1 illustrates social service payment system according to an exemplary embodiment of the present invention.

FIG. 2 illustrates a system that is configured to generate net calculation document according to an exemplary embodiment of the present invention.

FIG. 3 illustrates a gross payment document and a deduction plan document according to an exemplary embodiment of the present invention.

FIG. 4 illustrates a method to create a net calculation document according to an exemplary embodiment of the present invention.

FIG. 5 illustrates an example of creating net calculation documents using the method illustrated in FIG. 4.

FIG. 6 illustrates the created net calculation documents based on the example illustrated in FIG. 5.

FIG. 7 illustrates exemplary net calculation documents that further include deduction items.

### DETAILED DESCRIPTION OF THE EXAMPLE EMBODIMENTS

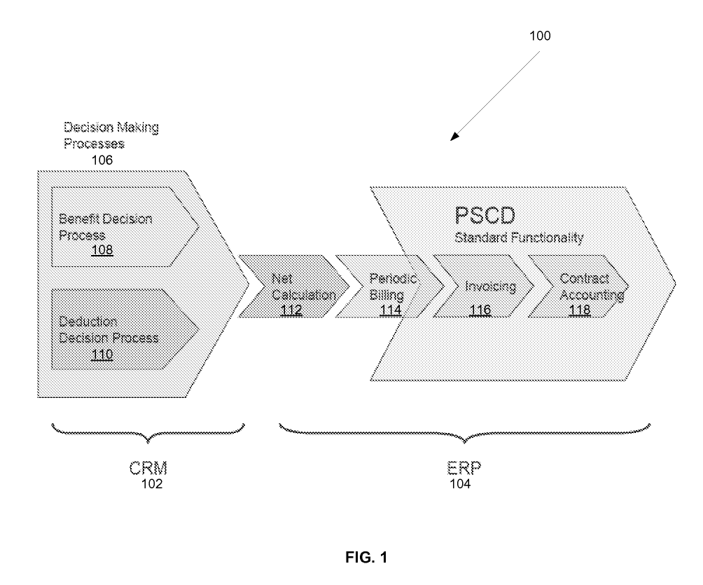

FIG. 1 illustrates social service payment system according to an exemplary embodiment of the present invention. The social service payment system 100 may include a decision making process 106 implemented on a customer relationship management (CRM) database system 102 and processes for calculating net payments and making payments implemented on an enterprise resource planning (ERP) database system 104. The decision making processes 106 further may include a benefit decision process 108 for determining a gross payment that a benefit recipient may be entitled to and a deduction decision process 110 identifying decision-based deductions and rule-based deductions that may be applicable to the benefit payments. The output of the benefit decision process may be a data object called a gross payment document, and the output of the deduction decision process may be a data object called a deduction plan document. An update of either the gross payment document or the deduction plan document may trigger a following net calculation process 112 implemented on the ERP.

The net calculation process may receive both the gross payment document and the deduction plan document for generating a data object called a net calculation document. The net calculation document may contain information for executing social service payments to the benefit recipient. The output of the net calculation in the form of net calculation document may trigger standard payment processes such as periodic billing 114, invoicing 116, and accounting 118. Like net calculation, these standard functionalities may be implemented on the backend ERP.

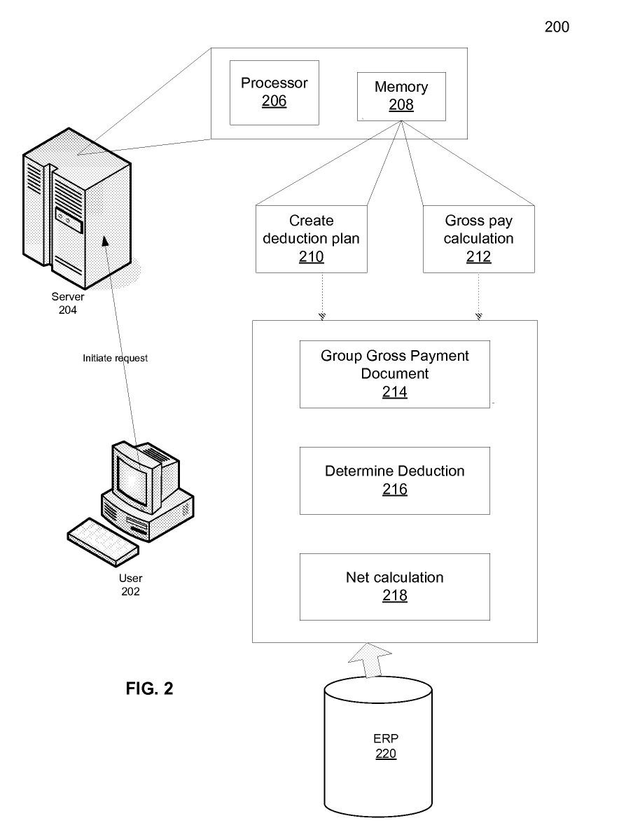

FIG. 2 illustrates a system that is configured to generate a net calculation document according to an exemplary embodiment of the present invention. The system 200 may include a server 204 that may include a processor 206 and a computer-readable storage medium 208. A user 202 (such as a social case worker) may access the server through a terminal.

The server may be configured with a CRM database application (not shown). The CRM application may support a first gross payment calculation module 212 for generating a gross payment document and a second deduction plan module 210 for generating a deduction plan document. The gross payment document may be a data object that contains information relating to the gross amount of money that a social benefit recipient may be entitled to; the deduction plan document may be a data object that contains information relating to deductions from the gross payment.

The server may further be configured with an ERP backend database application. The ERP application may receive the gross payment document and the deduction plan document from the CRM application to generate a net calculation document. The ERP application may be configured to perform: responsive to an update of at least one of the deduction plan document and gross payment document, grouping data items contained in the received gross payment document into net calculation units based on certain characteristics of these data items 214, determining decision-based deductions and rule-based deductions that are applicable to the gross payment document 216, and then generating a net calculation document 218 based on the net calculation units and the determined deductions.

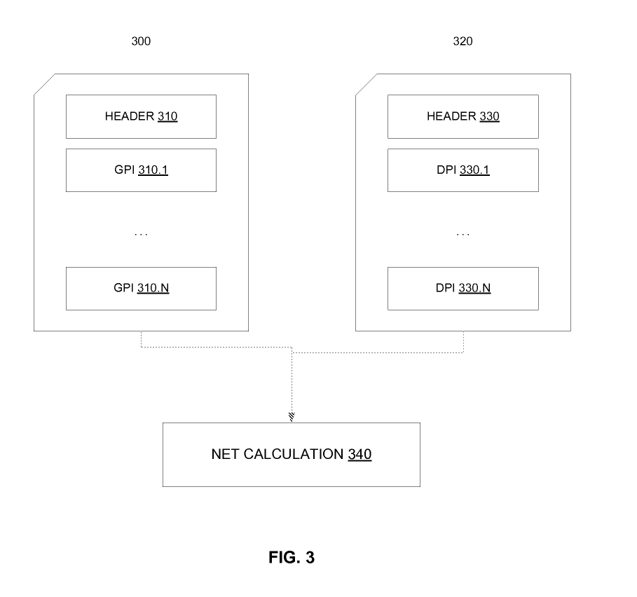

FIG. 3 illustrates an exemplary gross payment document 300 and an exemplary deduction plan document 320. As shown in FIG. 3, a gross payment document 300 may be a data object that may include a header 31 and a list of gross payment items 310.1 to 310.N. N may be an integer number greater than or equal to one. Each gross payment item (GPI) may be associated with a social service entitlement. For example, when a pension is supplemented in June 2009 that is retroactive to February 2009, a recipient may be entitled to one payment for a new monthly supplementary pension starting in June 2009; one for the underpayments of the existing pension for the months of February, March, April, and May of 2009; and one for the changed pension for time from June 2009 to January 2010. Thus, N may represent the number of frequency periods covered by a gross payment document and corresponding entitlement document. One gross payment item per entitlement may ensure a one to one relationship between gross payment items to entitlement items. This may be especially useful, because entitlement attributes may be unambiguously related to GPIs. In addition, later splits of GPIs during calculation may be prevented, because entitlement frequency periods are the smallest portion of time period. Further, existing GPIs that have already been calculated but not yet paid out may be stopped for each GPI as a whole. For example, a gross payment item with a future due date (relative to a reference date to be described below) may be calculated for a payment period, and later a new gross payment item may be calculated to replace the older GPI. The existing gross payment item may be rendered obsolete and stopped. This may be referred to as “delimited.”

Also as shown in FIG. 3, the deduction plan document 320 may be a data object that may include a header 330 and a list of deduction plan items 330.1 to 330.N where N is an integer greater than or equal to 1. Each deduction plan item (DPI) may be a decision-based deduction or a rule-based deduction. The decision-based deduction may be manually created by a social service case worker using a GUI implemented on a CRM. The decision-based deduction may be globally applicable to all GPIs. The rule-based deductions may be implemented using Business Add-Ins (BAdI) based on the rules applicable to particular GPIs. The CRM application may select which rule-based deductions to apply based on pre-defined filter values. Thus, rule-based deductions may be applied to only a subset of GPIs. Thus, each DPI may include an identifier to identify what the deduction is for. Further, each DPI may include an amount of deductions. The deduction may be either a fixed amount or a percentage of the gross payment. However, partial payment may also be supported. The DPIs may be prioritized. Thus, some DPIs may be applied first according to their priorities. The deductions are applied according to their priorities until the deducible amount is zero. A change to GPIs or DPIs may cause further net calculation process 340 to generate a further data object called net calculation document.

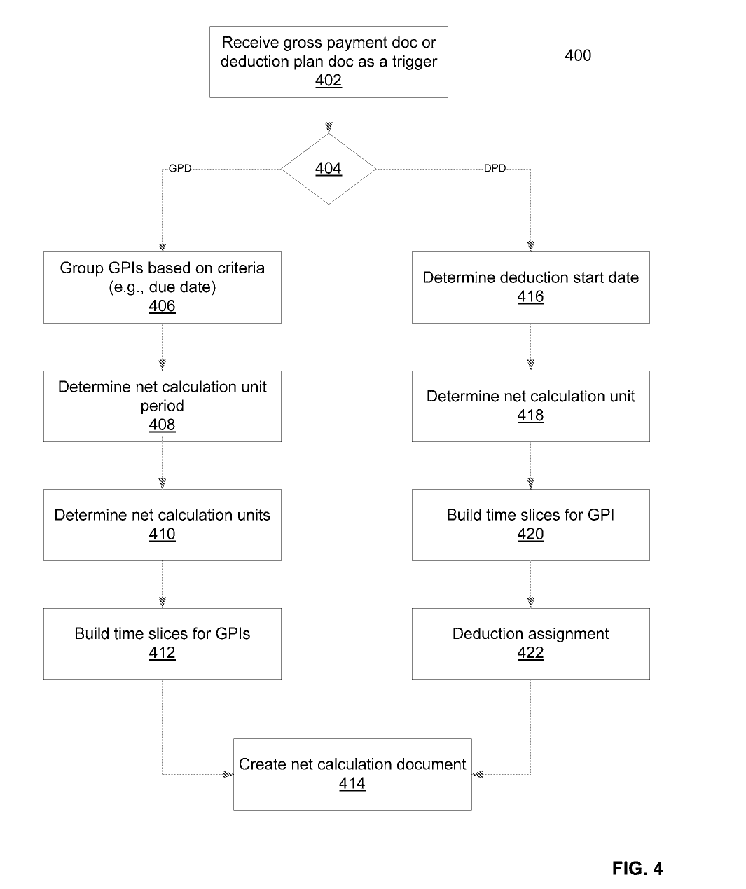

FIG. 4 illustrates a method to create a net calculation document according to an exemplary embodiment of the present invention. The method may be implemented on an ERP database system for generating a net calculation document. Responsive to receiving an updated gross payment document, the method may perform grouping GPIs 406, determining net calculation unit period 408, determining net calculation units 410, building time slices for GPIs 412, and creating net calculation documents 414. Alternatively, responsive to receiving an updated deduction plan document, the method may perform determining a deduction start date 416, determining net calculation units 318, building time slices for GPIs 420, assigning deductions 422, and creating net calculation documents 414. Specifics of the method are provided in the following.

The method may include receiving a gross payment document that contains at least one new gross payment item (GPI) or receiving a new deduction plan document created by a social service case worker 402. At 404, the method may determine which data object has been updated. If the gross payment document is updated with new GPIs, at 406, the method may group the new and existing active GPIs based on a set of criteria. For example, the GPIs may be grouped based on payment recipients/deduct-from-party, benefit programs, the frequency of payments/deductions, or the due dates of payments. GPIs with identical or substantially similar grouping criteria may be grouped into respective groups. A payment family may be a group for one or more benefit programs (SSP) that have the same payment frequencies. SSP with different payment frequency may not be grouped into one payment family.

At 408, the method may determine a net calculation unit (NCU) period for all groups. The net calculation unit period may be the time span over all of the grouped GPIs. At 410, the method may determine net calculation units (NCUs). NCUs are groups of Gross Payment Items (GPIs) to a same payment recipient, a same payment family (implicitly, same payment frequency), a same due date rule all within a defined net calculation unit period. Thus, the NCUs may be determined by selecting all activated GPIs that have the same grouping criteria and have due period within the net calculation unit period. The determination of net calculation unit may include identifying existing GPIs within the same NCU period. Identical calculations may be applied to all GPIs within the same NCU.

At 412, the method may build time slices for GPIs. Time slice is a time period that spans one or more payment frequency intervals (or billing periods) to assist the calculation process. The time slice may vary during net calculation (e.g., becomes more granular). For example, the time slice may become more granular during tax calculation. If the tax range changes within one time slice, the original time slice may be split into two time splices. The time slices may initially be obtained by dividing a GPI into time slices delimited at the borders between different GPIs. At the end, the original time period of the GPIs may be divided into homogenous time slices each of which has a same start and end date for payments, a same amount of payment, and a same due date. The combination of all time slices may cover the time period of all active GPIs. Finally, at 414, the method may create a net calculation document for each time slice.

If the deduction plan document is updated with new deduction plan items, at 416, the method may determine deduction start and end dates and based on the deduction start date, select deduction plan items (DPIs) that may need recalculation. Thus, the deduction start date may be retroactive to a date prior to current date or prospective to a date in the future. GPIs and DPIs that fall within the range of the start and end dates may be activated for net calculations. At 418, the method may determine net calculation unit by selecting all activated GPIs for the received GPD that may have the same grouping criteria and have due period within the net calculation unit period. The determination of net calculation unit may include identifying existing GPIs within the same NCU period. At 420, the method may build time slices for GPIs. The original time period of the GPIs may be divided into time slices each of which may have a same start and end date for payments, a same amount of payment, and a same due date. The combination of all time slices may cover the time period of all the GPIs. At 422, the method may assign deductions or DPIs to the active GPIs based on deduction priority. In one embodiment, some deductions may have higher priorities than others. Therefore, the deductions may be assigned according to which the deductions may be taken out first. Finally, at 414, the method may create a net calculation document for each time slice.

The net calculation document (NCD) may be a data object that may include a header and data items associated with the header. The NCD header may include data entries relating to start date of the payment period, end date of the payment period, due date (or date for payment), payment family (or social service program), payment recipient, due date rule, status of the NCD (such as Open, Billed, Revised, Cancelled, Reversed), billing document number, and reversal billing document number. The NCD header may also include additional user-defined fields. Thus, for each due date, a separate NCD document header may be created to serve as input for the subsequent billing process. The NCD data items may include data entries relating to gross payment items and/or deduction plan items, monetary amount, currency, benefit recipient id, item process class (such as regular or unemployment), deduction type (decision-based or rule-based), deduction plan item categories (such as third party, allocated deduction etc.), deduct-to party, and user-defined fields. In an exemplary embodiment of the present invention, different NCD headers may share a same NCD data item to form different NCDs. For example, when a recipient is entitled to receive identical gross payments and deductions for the months of January, February, and March, three NCD headers for January, February, and March may be created, each being linked to the same NCD item representing the gross payment and deductions of the benefit recipient.

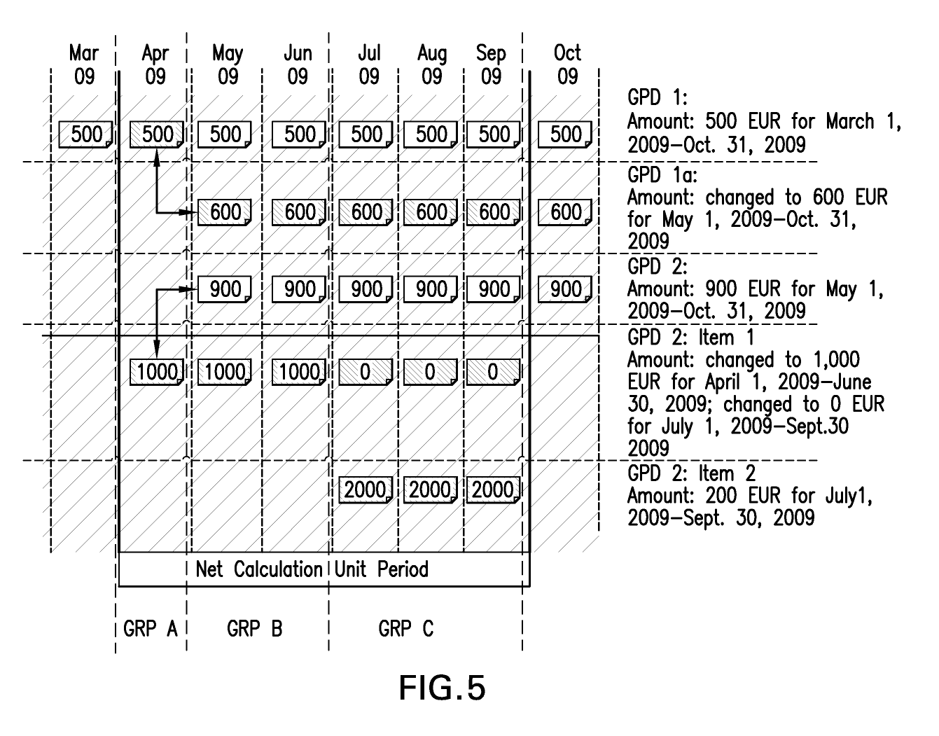

FIG. 5 illustrates an example of creating net calculation documents using the method illustrated in FIG. 4. For the time period of March to October 2009, the benefit recipient may receive a number of social service benefits which may be subject to changes during the time period. In this example, the recipient may receive a first entitlement of 500 EUR in March 2009. However, the first entitlement may be changed to 600 EUR starting May 2009. The recipient also may be scheduled to receive a second social service benefit starting in May 2009. However, before the second social service benefit starts, the start date to the April 2009 and the amount is changed to 1000 EUR. Also, for July-September 2009, the second benefit will be temporarily increased to 2000 EUR, and after September 2009, changed back to 900 EUR.

Responsive to receiving gross payment document 1 reflecting an update to its GPI for the change of 500 to 600 EUR and gross payment document 2 reflecting updates to its GPIs for the change of start date change and amount changes, the net calculation process may group the updated GPIs into groups based on the criteria of homogeneous payments. For this example, the GPIs may be divided into three groups with Group A covering April 2009, Group B covering May and June 2009, and Group C covering July-September 2009. In Group A, the total amount of payment is 500+1,000 EUR=1,500 EURs. In Group B, the total amount is 600+1,000 EUR=1,600 EURs. In Group C, the total amount is 600+2,000=2,600 EURs. Next, the net calculation may determine the net calculation unit period based on activated GPIs. For this example, the NCU period spans from April 2009 to September 2009 since it is the time period that the GPIs need updates. Further, NCUs are determined. As discussed above, NCUs are groups of Gross Payment Items (GPIs) to a same payment recipient, a same payment family (implicitly, same payment frequency), a same due date rule all within a defined net calculation unit period. For this example, the NCUs are incidentally the same as the time period for each group, i.e., corresponding to the time period of April, May-June, and July-September 2009. Finally, the time slices in this example are monthly based on payment dates are monthly.

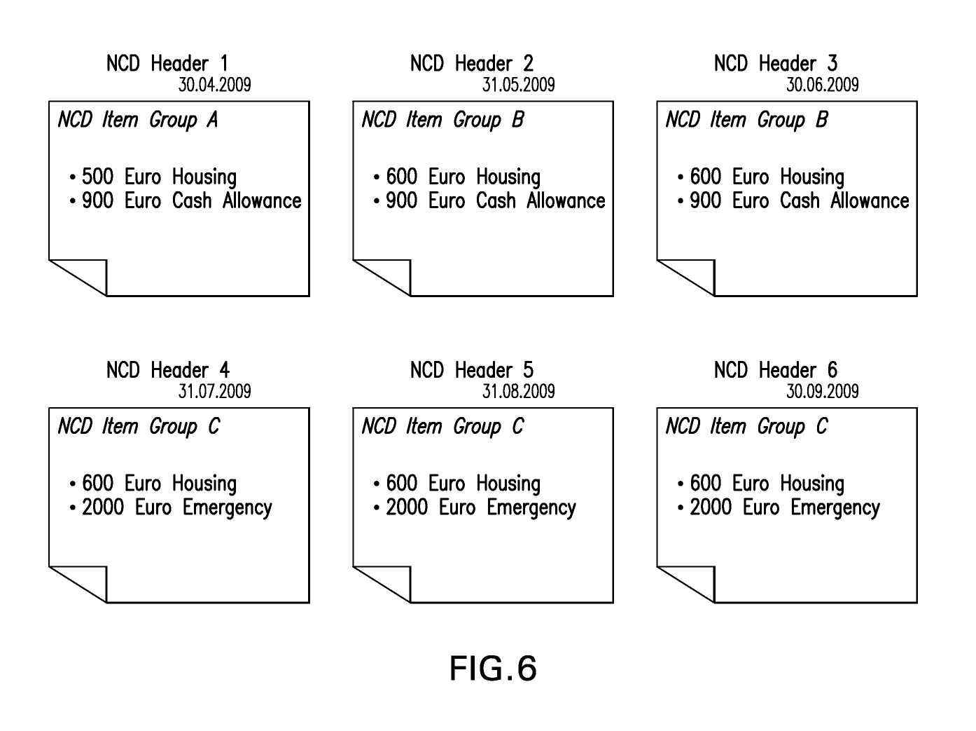

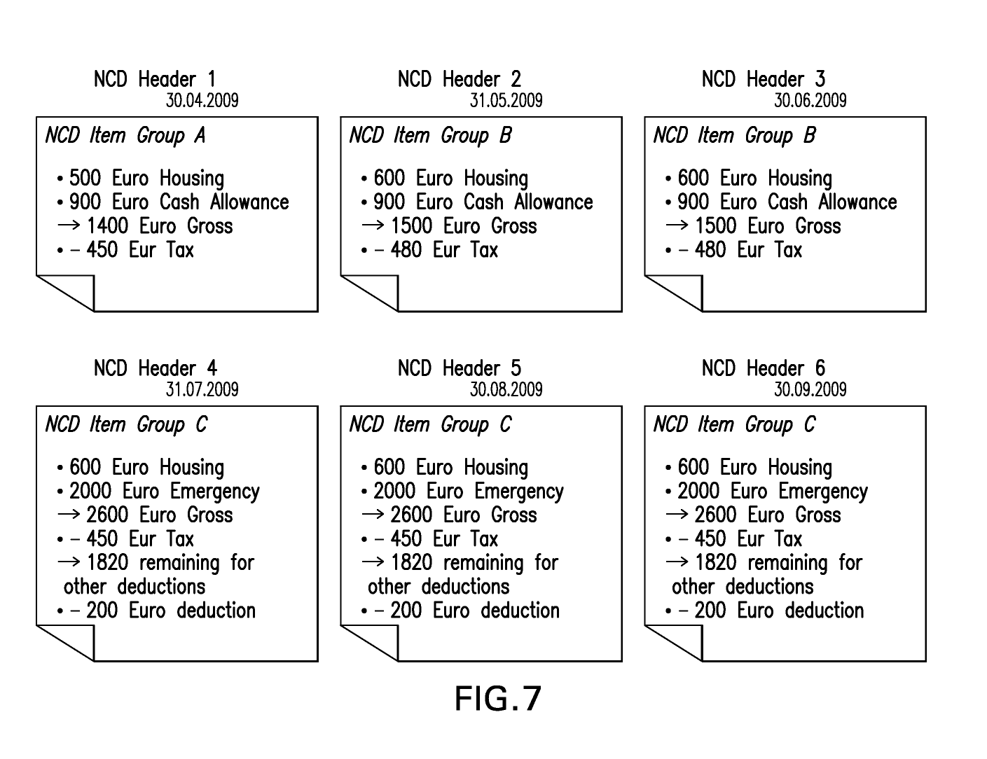

FIG. 6 illustrates the exemplary net calculation documents created based on the example illustrated in FIG. 5. Total six new NCDs for the six months from April-September 2009 are created. Each NCD may have a header indicating which group the NCD belongs to. Further, each NCD includes data items indicating the amounts of payments and what is the item for. FIG. 7 illustrates exemplary net calculation documents that further include deduction items. The created NCDs may then be transferred to the standard payment process for procuring payments, invoicing, and accounting.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. Further, those embodiments may be used in various combinations with and without each other. The present invention as claimed therefore includes variations from the specific examples and embodiments described herein, as will be apparent to one of skill in the art.

What is claimed is:

1. A computer-implemented method of generating net calculation documents for issuing benefits to a recipient, comprising:
receiving, by a processor, gross payment documents (GPDs) each including a plurality of gross payment items (GPIs) each including a benefit amount the recipient is entitled to and deduction plan documents (DPDs) each including a plurality of deduction plan items (DPIs) each including a deduction amount from a corresponding GPI;
responsive to receiving one of an update to at least one of the GPIs in a GPD and at least one new GPI in the GPD,
grouping, by the processor, all GPIs in the GPD into groups based on pre-determined criteria;
determining, by the processor, a time period that extends over the all GPIs that are affected by the updated/new GPIs and need recalculation;
determining, by the processor, net calculation units (NCUs) each unit having an identical payment frequency;
dividing, by the processor, the NCUs into homogeneous time slices based on benefit payment dates;
for each time slice, generating, by the processor, a net calculation document (NCD) including a header, a plurality of GPIs and DPIs for the time slice; and
transmitting, by the processor, the created NCDs to a payment process for issuing the benefits to the recipient.

2. The method of claim 1, further comprising:
responsive to receiving one of an update to at least one of the DPIs and at least one new DPI,
determining, by the processor, a start date for the updated/new DPIs;
determining, by the processor, net calculation units (NCUs) each unit having an identical payment frequency;
dividing, by the processor, the NCUs into homogeneous time slices based on benefit payment dates;
assigning, by the processor, DPIs to their corresponding GPIs;
for each time slice, generating, by the processor, a NCD including a header, a plurality of GPIs and DPIs for the time slice; and
transmitting, by the processor, the created NCDs to a payment process for issuing the benefits to the recipient.

3. The method of claim 1, wherein:
the method is executed on an enterprise resource planning (ERP) database application;
the update/new GPIs are generated through a user interface resided on a customer relationship management (CRM) database application; and
the update/new GPIs are transmitted from the CRM to the ERP.

4. The method of claim 2, wherein:
the update/new DPIs are generated through a user interface resided on the CRM database application; and
the update/new DPIs are transmitted from the CRM to the ERP.

5. The method of claim 1, wherein the pre-determined criteria include a requirement that all GPIs within a group have identical payments.

6. The method of claim 1, wherein the pre-determined criteria include a requirement that all GPIs within a group have identical due dates.

7. The method of claim 1, wherein the time slices cover one of a week and a month.

8. A system for generating net calculation documents for issuing benefits to a recipient, comprising:
a processor, and
a storage memory coupled to the processor, the processor configured to:
receive gross payment documents (GPDs) each including a plurality of gross payment items (GPIs) each including a benefit amount the recipient is entitled to and deduction plan documents (DPDs) each including a plurality of deduction plan items (DPIs) each including a deduction amount from a corresponding GPI;
responsive to receiving one of an update to at least one of the GPIs in a GPD and at least one new GPIs in the GPD,
group all GPIs in the GPD into groups based on pre-determined criteria;
determine a time period that extends over all GPIs that are affected by the updated/new GPIs and need recalculation;
determine net calculation units (NCUs) each unit having an identical payment frequency;
slice the NCUs into homogeneous time slices based on benefit payment dates;
for each time slice, generate a NCD including a header, a plurality of GPIs and DPIs for the time slice; and
transmit the created NCDs to a payment process for issuing the benefits to the recipient.

9. The system of claim 8, wherein the processor is further configured to:
responsive to receiving one of an update to at least one of the DPIs and at least one new DPIs,
determine a start date for the updated/new DPIs;
determine net calculation units (NCUs) each unit having an identical payment frequency;
dividing the NCUs into homogeneous time slices based on benefit payment dates;
assigning DPIs to their corresponding GPIs;
for each time slice, generate a NCD including a header, a plurality of GPIs and DPIs for the time slice; and
transmit the created NCDs to a payment process for issuing the benefits to the recipient.

10. The system of claim 8, wherein:
the processor is configured with an enterprise resource planning (ERP) database application and a customer relationship management (CRM) database application;
the update/new GPIs are generated through a user interface resided on the CRM database application; and
the update/new GPIs are transmitted from the CRM to the ERP.

11. The system of claim 9, wherein:
the update/new DPIs are generated through a user interface resided on the CRM database application; and
the update/new DPIs are transmitted from the CRM to the ERP.

12. The system of claim 8, wherein the pre-determined criteria include a requirement that all GPIs within a group have identical payments.

13. The system of claim 8, wherein the pre-determined criteria include a requirement that all GPIs within a group have identical due dates.

14. The system of claim 8, wherein the time slices cover one of a week and a month.

15. A computer-readable storage medium stored thereon executable code that when executed, performs a method generating net calculation documents for issuing benefits to a recipient, the method comprising:
receiving, by a processor, gross payment documents (GPDs) each including a plurality of gross payment items (GPIs) each including a benefit amount the recipient is entitled to and deduction plan documents (DPDs) each including a plurality of deduction plan items (DPIs) each including a deduction amount from a corresponding GPI;
responsive to receiving one of an update to at least one of the GPIs in a GPD and at least one new GPIs in the GPD,
grouping, by the processor, all GPIs in the GPD into groups based on pre-determined criteria;
determining, by the processor, a time period that extends over all GPIs that are affected by the updated/new GPIs and need recalculation;
determining, by the processor, net calculation units (NCUs) each unit having an identical payment frequency;
dividing, by the processor, the NCUs into homogeneous time slices based on benefit payment dates;
for each time slice, generating, by the processor, a NCD including a header, a plurality of GPIs and DPIs for the time slice; and
transmitting, by the processor, the created NCDs to a payment process for issuing the benefits to the recipient.

16. The computer-readable storage medium of claim 15, wherein the method further comprising:
responsive to receiving one of an update to at least one of the DPIs and at least one new DPIs,
determining, by the processor, a start date for the updated/new DPIs;
determining, by the processor, net calculation units (NCUs) each unit having an identical payment frequency;
dividing, by the processor, the NCUs into homogeneous time slices based on benefit payment dates;
assigning, by the processor, DPIs to their corresponding GPIs;
for each time slice, generating, by the processor, a NCD including a header, a plurality of GPIs and DPIs for the time slice; and
transmitting, by the processor, the created NCDs to a payment process for issuing the benefits to the recipient.
